(19) United States
(12) Patent Application Publication
(10) Pub. No.: US 2017/0032376 A1
(43) Pub. Date: Feb. 2, 2017

(54) Extended Service Agreement Offers

(71) Applicant: Adam Blackmon, Fishers, IN (US)

(72) Inventor: Adam Blackmon, Fishers, IN (US)

(21) Appl. No.: 14/922,069

(22) Filed: Oct. 23, 2015

Related U.S. Application Data
(60) Provisional application No. 62/067,643, filed on Oct. 23, 2014.

(51) Int. Cl. G06Q 30/00

(52) U.S. Cl. CPC G06Q 30/012

(57) ABSTRACT

When a vehicle is sold to a customer, the manufacturer or seller of the vehicle may configure the vehicle with an integrated vehicle protection program in order to provide the customer with information about warranty protection that the vehicle may have, as well as to provide opportunities to maintain or extend protection beyond the original warranty through a service contract. A device within a vehicle such as the media center or navigation screen may be configured to display notifications relating to the vehicle's current mileage or time-in-service as they relate to warranty protection that the vehicle may have. A series of notifications may be provided as the vehicle nears a warranty expiration event. Notifications may have information or controls that may be used to purchase additional coverage or service contract through the manufacturer or dealer.

### REFERENCE TO RELATED APPLICATION

This application claims priority to and is a nonprovisional of U.S. Provisional Application No. 62/067,643, filed on Oct. 23, 2014, with title “Extended Service Agreement Offers.”

### FIELD

The present invention relates to facilitating transactions between auto manufacturers and car owners. More specifically, the present invention relates to systems and methods for offering and accepting purchase of extended service agreements and other transactions.

### BRIEF DESCRIPTION OF THE DRAWINGS

FIG. 1 is a flowchart illustrating operation of an exemplary system where the customer purchases a vehicle service contract with the vehicle.

FIG. 2 is a flowchart illustrating operation of the system from the point of view of the customer.

FIG. 3 is an exemplary notice for use in various embodiments of the present system.

FIG. 4 is an exemplary information page for use in connection with the notice of FIG. 3.

FIG. 5 is a flowchart illustrating operation of the system from the point of view of the manufacturer.

FIG. 6 shows a variety of extended service contract terms available in some embodiments of the present system.

FIG. 7 is a flowchart illustrating another embodiment of the present system.

FIG. 8 is a flowchart illustrating consequences of purchase decisions in the system of FIG. 7.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

Generally, one form of the present system uses one or more in-vehicle displays to provide offers of extended service agreements to vehicle owners in advance of the expiration of their manufacturer's warranty protection. The system can accept extensions of coverage through purchase transactions initiated by interaction in response to the offers. Timing of the offers is, in various embodiments, a function of actual mileage, actual time since delivery of the vehicle, the vehicle manufacturer's standard warranty protection, and the owner's elections concerning the manufacturer's and third-party warranty and service agreement protection.

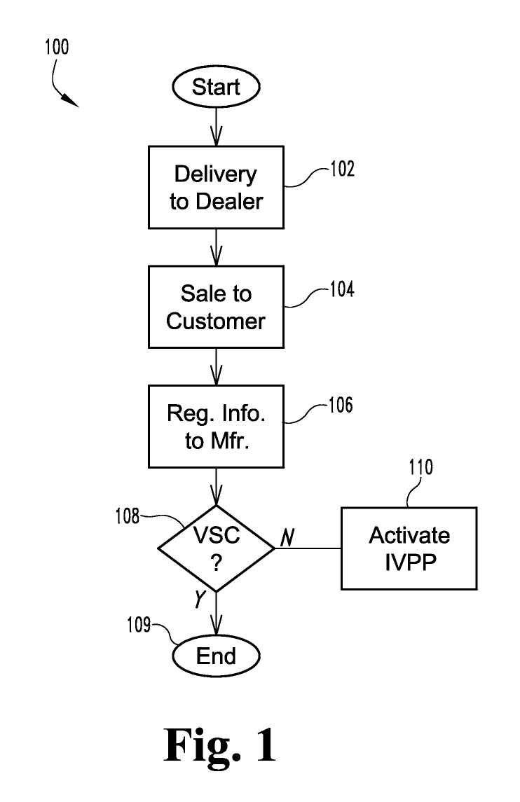

A flowchart illustrating an extended service agreement management process 100 in one embodiment of the present system is shown in FIG. 1 At step 102, the manufacturer delivers a vehicle to a dealer by transport. The dealer performs a pre-delivery inspection on the vehicle. At step 104, the dealer sells the vehicle to a customer and, at step 106, submits the vehicle registration to the manufacturer. At decision step 108, it is determined whether the customer purchased a vehicle service contract through the dealer. In various situations, the vehicle service contract offered by the dealer may be an extended service agreement supplied by the manufacturer or one offered by a third party. If so (a “yes” result at step 108 in FIG. 1), the exemplary process shown in FIG. 1 ends at step 109 with no activation of the integrated vehicle protection program (IVPP).

If no vehicle service contract/extended warranty is sold with the vehicle (a negative result at step 108), the manufacturer activates the IVPP at step 110. The IVPP program stays active until the original warranty expires; the customer purchases a vehicle service contract, either from a dealer or through the IVPP; the vehicle is declared a total loss due to accident, flood, or the like; the customer cancels the contract; or the vehicle is traded or sold. In that letter case, if the original warranty is still in effect, the IVPP in some embodiments automatically transfers to the new owner, while in other embodiments, the manufacturer or original customer has the option to transfer the benefit of the IVPP to the new owner. If the IVPP remains active, the new owner receives some or all of the notifications and/or offers described herein and can avail himself or herself of the advantages thereof, including offers of extended vehicle service contracts, preferably to the same extent as could the original owner.

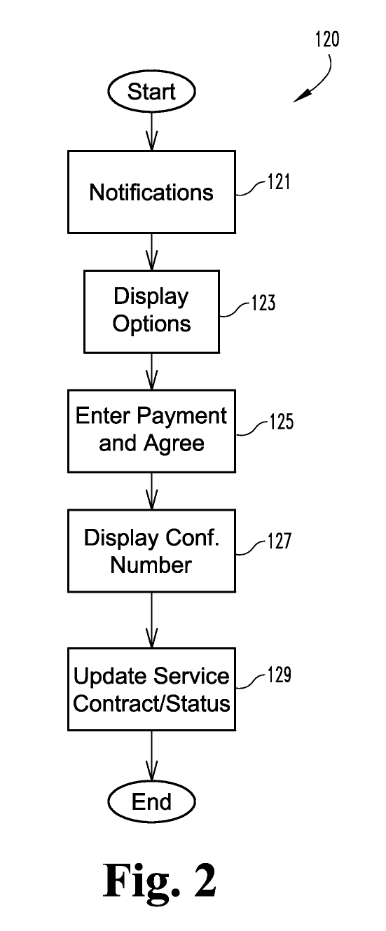

Operation of the IVPP, as seen from the perspective of the vehicle owner, will now be explained as process 120 with reference to FIG. 2. At one or more times, an LCD screen, navigation screen or other display in the vehicle shows (121) notification of the warranty status, expiration date, and maximum mileage. In some embodiments, this display uses the same interface as other informational notices shown to the car operator. In some embodiments, notifications are alternatively or additionally sent to the vehicle owner by email to an address on file with the original equipment manufacturer or finance company. And in some embodiments, these notices and interactions are conducted in an app running on a computing system built into the vehicle; on a mobile phone or computer operated by the vehicle's owner, driver, passenger, or other person; or on a combination of multiple such devices.

In some embodiments, the notifications direct the customer to (or offer to connect the customer with) the original equipment manufacturer, the dealer or other seller from whom the vehicle was originally purchased, the nearest authorized dealer, or other resource capable of assisting the customer with the purchase of a vehicle service contract. In various embodiments, when a customer purchases a vehicle service contract through the IVPP, in incentive or compensatory payment is made to one or more involved parties, such as the original equipment manufacturer, the company who handled the original financing, the dealer through whom the vehicle was originally sold, or the like.

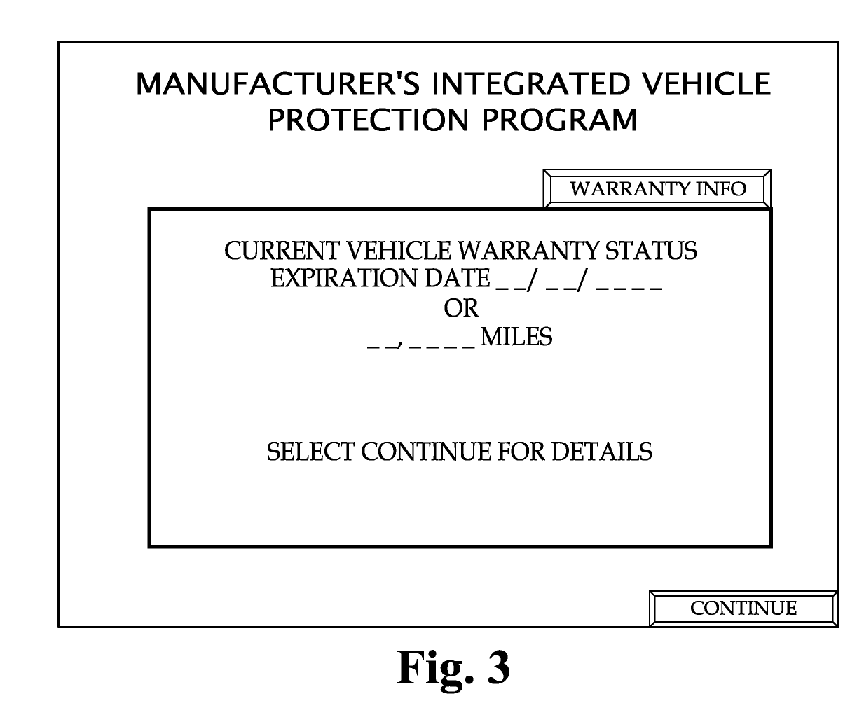

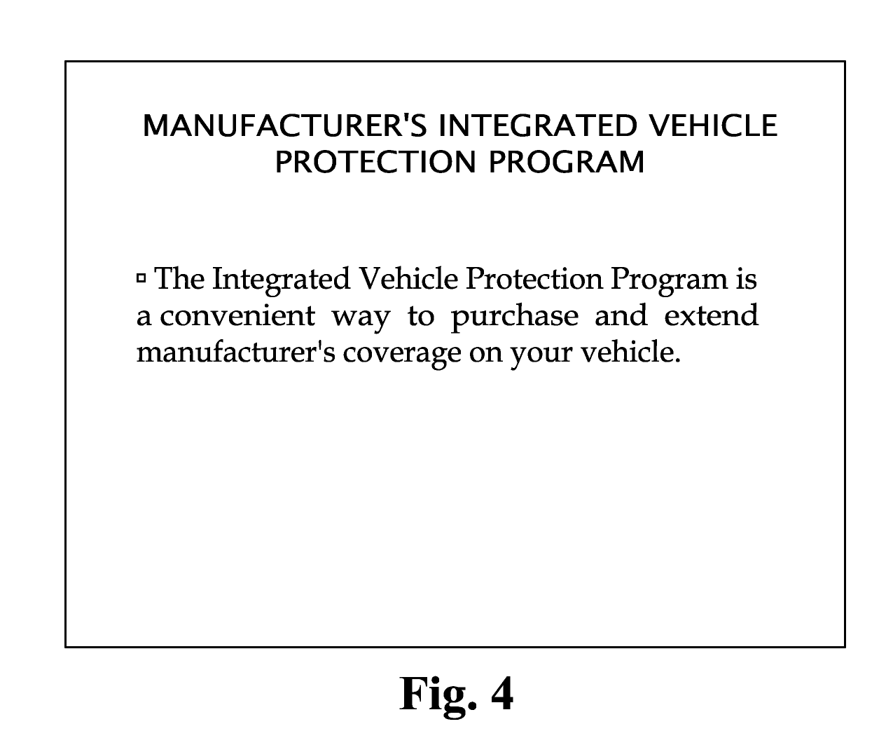

It should be understood that, in some implementations, the IVPP notices are displayed only upon switching-on of the ignition, while in others the notices are shown at any time during operation of the vehicle, and in still others the notices are shown only when the vehicle is stopped or at other times as will occur to those skilled in the art. An exemplary format of the notices is shown in FIG. 3. Additional information or “help” text may be available using the standard interface elements (e.g., via an “information” icon or the like) and might be displayed with content shown for example in FIG. 4.

In one embodiment, notifications for warranty status, expiration, and other characteristics may be tracked and generated by the vehicle's built-in system(s) alone, such as by tracking mileage or service time in the vehicle's ECU, ECM, navigation system, or media system, and generating notifications based upon pre-configured triggers. In another embodiment, notifications for warranty status may be tracked and generated by a remote server communicatively coupled with the vehicle's built-in systems, directly or indirectly, by way of one or more wired connections, such as a USB, Ethernet, OBD-II, or other similar wired connections, and/or one or more wireless connections, such as by Wi-Fi, Bluetooth, cellular or mobile data networks, satellite data networks, or similar wireless connections. Depending upon each particular implementation, wireless communication with a remote server may be accomplished at any time, just as wired communication occurs in some systems during a vehicle's regular service intervals.

If the car owner requests more information about the available coverage plans, the system displays (123 in FIG. 2) coverage plan options and prices and accepts the owner's selection from among them. In some embodiments, the customer can then enter (125 in FIG. 2) payment information using the LCD touch screen and agree to the terms of the contract. If the customer needs further assistance, they can activate an interface element (e.g., a button in the graphical user interface) and be connected to a representative via voice link, such as by cellular telephone, satellite phone, VoIP, or other voice connection as will occur to those skilled in the art. The contract and/or confirmation number(s) are provided (127 in FIG. 2) to the customer on the display. If the manufacturer has an email address on file (such as from the original purchase transaction), and/or if the customer provides one as part of the in-vehicle transaction, a receipt may automatically be sent to that email address. The service contract and status for the vehicle are then updated (129 in FIG. 2).

In various embodiments, the notices provided in connection with this system and method are triggered at various times, where those times are sometimes specified by the manufacturer. For example, notices may be triggered 12, 6, 3, and 1 month before expiration of the original manufacturer's warranty, or alternatively 24, 12, and 1 month before. In some of these embodiments, the notices may be accelerated when the mileage on the vehicle is accruing faster than the rate at which the time period is passing for the respective warranty.

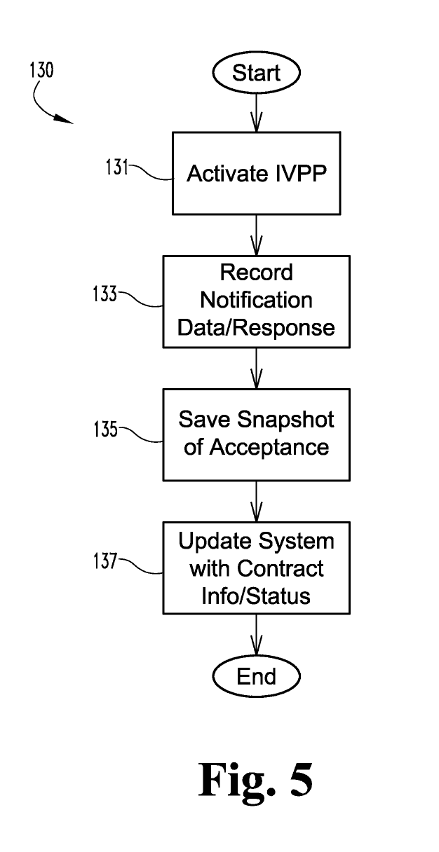

The manufacturer's perspective on the system is illustrated in FIG. 5. As discussed above, following delivery, the manufacturer activates or initiates (131) the IVPP software, and it stays active, perhaps until the expiration of the manufacturer's warranty. When the warranty status/notification is displayed on the LCD/navigation/other display device in the vehicle, both the display event and the owner's response are recorded (133) and, in some embodiments, communicated to the manufacturer's server. In some embodiments, this information includes the date, time, location, and vehicle mileage when the notification was displayed. Similarly, if the owner accepts the extended service contract offer and completes payment, the date, time, and vehicle mileage are saved (135) for documentation of the service contract. The manufacturer's dealer-accessible database is updated (137) with the new service contract information so that the owner of the vehicle can obtain dealer service immediately upon acceptance.

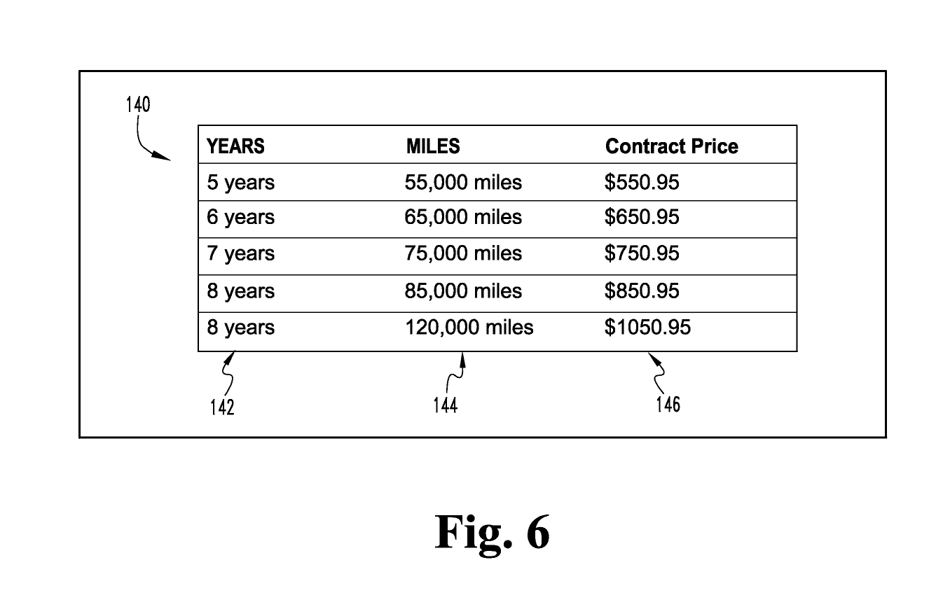

In some embodiments, the notices include a variety of options with respect to extended service contracts. As shown in an exemplary collection in FIG. 6, this variety may include variations in the number of miles (144) and/or the number of years (142) defining the end of the service contract, and these variations are naturally reflected in the corresponding prices (146).

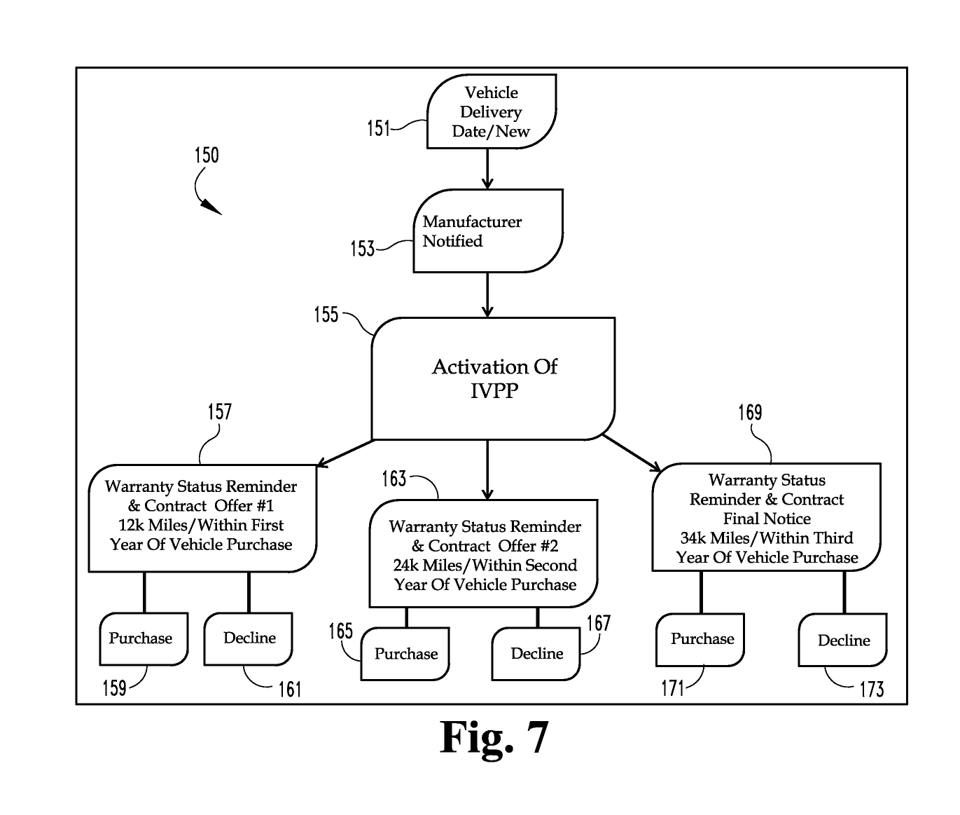

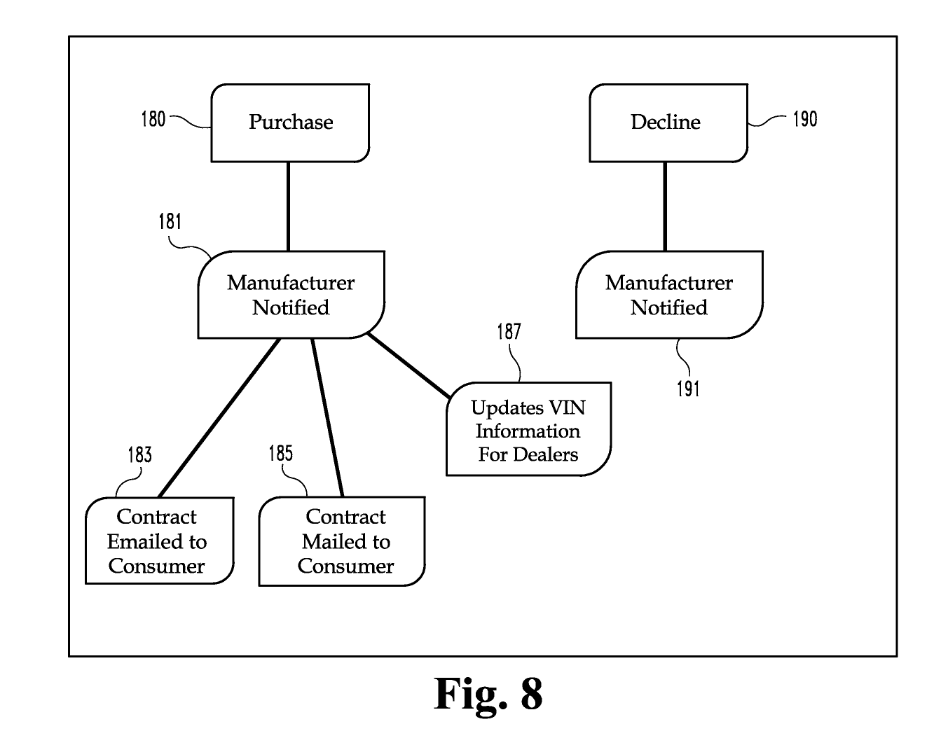

Another view (150) of the process according to this disclosed system is illustrated in FIGS. 7-8. Again, the date of delivery of the new vehicle is recorded (151), and the manufacturer is notified (153) of the sale. The IVPP system is activated (155), and warranty status reminders and contract offers are presented at programmed intervals. In this example, the first offer is presented (157) after the vehicle has traveled about 12,000 miles and/or about one year has passed since delivery of the vehicle. If the owner purchases (159) the extended service contract (see FIG. 8 at 180), the manufacturer is notified (181), a copy of the contract is sent to the purchaser by email (183) and paper mail (185), and the manufacturer updates (187) the contract information associated with that particular vehicle's VIN for reference by authorized dealers.

If, on the other hand, the owner declines (161) this first offer, the manufacturer is notified of this event. Another warranty status reminder and contract offer is presented (163) about one year later, or after the vehicle mileage reaches about 24,000. Again, the owner has an opportunity to purchase (165) or decline (167) the offer, in response to which the system takes action as described just above.

A final offer is presented (169) after about 34,000 miles and/or just under three years following delivery of the vehicle. Acceptance (171) of the offer at this point results in the same updates. Declining (173 in FIG. 7, 190 in FIG. 8) the offer again, however, yields documentation of that decision as discussed above, but also deactivation of the IVPP software and notification (191) of the manufacturer.

In various embodiments, the distances and durations related to reminders, warranty services, and the like described in this application are based on the original delivery of the vehicle by an authorized dealer to the original customer. In some embodiments, the baseline for such distances and time frames is adjusted when circumstances influence the base time and odometer reading on which the original warranty is calculated. For example, if a purchaser of a vehicle avails himself or herself of a three-day return policy, and a subsequent purchaser of the same vehicle has his or her warranty calculated from the subsequent purchase date and mileage, the reminders calculated by the IVPP are preferably calculated from the subsequent purchase date and mileage, too.

The various activities performed by the various implementations of this system and method are implemented using special programming stored in a memory device and executed by a processor, all as will occur to those skilled in the art. For example, a “computer,” as this example will generically be referred to, includes a processor in communication with a memory, input interface(s), output interface(s), and a network interface. The memory stores a variety of data, but is also encoded with programming instructions executable to perform the functions described herein. Power, ground, clock, and other signals and circuitry are used as appropriate as will be understood and easily implemented by those skilled in the art.

The network interface connects the computer to a data network for communication of data between the computer and other devices attached to a data network, such as cellular, satellite, Wi-Fi, WiMAX, or other system as will occur to those skilled in the art. The input interface(s) manage communication between the processor and one or more touch screens, sensors, pushbuttons, UARTs, IR and/or RF receivers or transceivers, decoders, or other devices, as well as traditional keyboard and mouse devices. Output interface(s) provide a video signal to a display, and may provide signals to one or more additional output devices such as LEDs, LCDs, or audio output devices, local multimedia devices, local notification devices, or a combination of these and other output devices and techniques as will occur to those skilled in the art.

The processor in some embodiments is a microcontroller or general purpose microprocessor that reads its program from the memory. The processor may be comprised of one or more components configured as a single unit. Alternatively, when of a multi-component form, the processor may have one or more components located remotely relative to the others. One or more components of the processor may be of the electronic variety including digital circuitry, analog circuitry, or both. In some embodiments, the processor is of a conventional, integrated circuit microprocessor arrangement, such as one or more CORE i3, i5, or i7 processors from INTEL Corporation of 2200 Mission College Boulevard, Santa Clara, Calif. 95052, USA, or OPTERON or PHENOM processors from Advanced Micro Devices, One AMD Place, Sunnyvale, Calif. 94088, USA. In some embodiments, one or more reduced instruction set computer (RISC) processors, graphics processing units (GPU), application-specific integrated circuits (ASICs), general-purpose microprocessors, programmable logic arrays, engine control units, or other devices may be used alone or in combinations as will occur to those skilled in the art.

Likewise, the memory in various embodiments includes one or more types such as solid-state electronic memory, magnetic memory, or optical memory, just to name a few. By way of non-limiting example, the memory can include solid-state electronic Random Access Memory (RAM), Sequentially Accessible Memory (SAM) (such as the First-In, First-Out (FIFO) variety or the Last-In First-Out (LIFO) variety), Programmable Read-Only Memory (PROM), Electrically Programmable Read-Only Memory (EPROM), or Electrically Erasable Programmable Read-Only Memory (EEPROM); an optical disc memory (such as a recordable, rewritable, or read-only DVD or CD-ROM); a magnetically encoded hard drive, floppy disk, tape, or cartridge medium; a solid-state or hybrid drive; or a plurality and/or combination of these memory types. Also, the memory in various embodiments is volatile, nonvolatile, or a hybrid combination of volatile and nonvolatile varieties.

The term “computer-readable medium” herein encompasses non-transitory distribution media, intermediate storage media, execution memory of a computer, and any other medium or device capable of storing a computer program implementing a method for later reading by a computer.

Although the discussion above has generally been in terms of “warranties,” in each case the same applies to original warranties, extended warranties, original and extended vehicle service agreements, and other commitments by those other than the vehicle owner to maintain and/or repair the vehicle.

All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system for prompting extended service contract transactions related to a vehicle, the system comprising:
a display;
a processor; and
a memory in communication with the processor, wherein the memory is encoded with programming instructions executable by the processor to:
(i) receive and store a set of warranty data, the set of warranty data indicating that a vehicle has been purchased by an owner;
(ii) cause the display to display a first warranty status notification in response to the occurrence of a first warranty event, where the first warranty status notification comprises a set of instructions, the set of instructions describing one or more actions the owner may take in order to obtain an extended service contract (ESC);
(iii)upon receiving input consistent with the one or more actions, send an ESC request to a server, where the ESC request indicates that the owner intends to obtain the ESC.

2. The system of claim 1, wherein the programming instructions are further executable by the processor to:
(iv)receive and store an ESC confirmation, the ESC confirmation indicating that the ESC request was granted.

3. The system of claim 1, wherein the first warranty event occurs when the processor receives a signal indicating that the vehicle has been operated for a pre-configured distance.

4. The system of claim 1, wherein the programming instructions are further executable by the processor to cause the display to (iv) show a second warranty status notification and a third warranty status notification, each respectively viewable by the owner in response to the occurrence of a second warranty event and a third warranty event, wherein:
(a) the first warranty event occurs when the processor receives a signal indicating that the vehicle has been operated for about first predetermined distance;
(b) a second warranty event occurs when the processor receives a signal indicating that the vehicle has been operated for about second predetermined distance; and
(c) a third warranty event occurs when the processor receives a signal indicating that the vehicle been operated for about a third predetermined distance.

5. The system of claim 1, wherein the first warranty event occurs when the processor receives a signal indicating that the vehicle has been in service for at least a predetermined amount of time.

6. The system of claim 1, wherein the programming instructions are further executable by the processor to (iv) cause the display to display a second warranty status notification and a third warranty status notification, each respectively viewable in response to the occurrence of a second warranty event and a third warranty event, wherein:
(a) the first warranty event occurs when the processor receives a signal indicating that the vehicle has been in service for a first amount of time;
(b) a second warranty event occurs when the processor receives a signal indicating that the vehicle has been operated for a second amount of time; and
(c) a third warranty event occurs when the processor receives a signal indicating that the vehicle been operated for a third amount of time.

7. The system of claim 1, wherein the first warranty event is the earlier of:
when the processor receives a signal indicating that the vehicle has been in service for a first amount of time; and
when the processor receives a signal indicating that the vehicle has been operated for about first predetermined distance.

8. The system of claim 1, further comprising an input device situated within the vehicle, wherein the input device is communicatively coupled with the processor, and wherein the input device is configured to:
(a) receive the warranty request; and
(b) cause the warranty request to be transmitted to the server.

9. The system of claim 1, wherein the programming instructions are further executable by the processor to disable future displaying of the first warranty status notification in response to receiving a disable signal selected from the set of disable signals consisting of:
(a) an indication that an ESC has been purchased for the vehicle;
(b) an indication that the vehicle is no longer in service;
(c) an indication that the vehicle is no longer owned by the owner; and
(d) an indication that an original warranty for the vehicle expired.

10. The system of claim 1, wherein the display comprises one or more of:
(a) a navigation unit display;
(b) an instrument cluster screen;
(c) a multimedia device; and
(d) a touch screen of a mobile computing device.

11. An apparatus comprising:
(a) a vehicle comprising:
(i) a processor;
(ii) a display in communication with the processor;
(iii) a memory in communication with the processor; and
(iv) an input device in communication with the processor; and
(b) a transaction server, the transaction server communicatively coupled with the processor; wherein:
(A) the memory is encoded with programming instructions executable by the processor to:
(i) receive and store a set of warranty data, the set of warranty data indicating that the vehicle has been purchased by an owner; and
(ii) cause the display to display a warranty status notification in response to the occurrence of a first warranty event, wherein the first warranty event occurs when the processor receives a signal indicating that a pre-configured portion of the term of an original warranty has expired;
(B) the warranty status notification comprises a set of instructions describing one or more actions the owner may take with the input device in order to obtain an extended service contract (ESC);
(C) the transaction server is configured to:
(i) receive an ESC request from the processor, the ESC request indicating that the owner intends to obtain the additional warranty; and
(ii) provide an ESC confirmation, the warranty confirmation indicating that the additional warranty was granted;
(D) the processor is further configured to receive at least one disable signal selected from the set of disable signals consisting of:
(i) an indication that an alternate service contract has been purchased for the vehicle;
(ii) an indication that the vehicle is no longer in service;
(iii) an indication that the vehicle is no longer owned by the owner; and
(iv) an indication that an original warranty for the vehicle expired; and
(E) the processor is further configured to respond to receipt of the at least one disable signal by preventing the warranty status notification from being displayed.

12. A method comprising the steps:
(a) activating an integrated vehicle protection program for a vehicle by transmitting a signal to a processor in the vehicle;
(b) while the integrated vehicle protection program is activated, causing a warranty status notification to be displayed on a display in response to the occurrence of a first warranty trigger event, the warranty status notification comprising instructions for obtaining an additional service contract related to the vehicle;
(c) receiving, at a transaction server, an indication that the customer intends to obtain the additional service contract; and
(d) sending to the customer a confirmation that the additional service contract has been obtained.

13. The method of claim 12, wherein the indication that the customer intends to obtain the additional warranty is a transaction signal generated by an input device within the vehicle, wherein the input device is communicatively coupled with the transaction server.

14. The method of claim 13, wherein the transaction signal comprises a payment method and an indication that a set of terms and conditions have been accepted.

15. The method of claim 12, wherein the indication that the customer intends to obtain the additional warranty is a set of data received by a sales agent during a telephone call made by the customer.

16. The method of claim 12, wherein:
the warranty status notification comprises at least one of an expiration date and an expiration mileage for an original warranty, and
the warranty status notification comprises an additional service contract description and an additional service contract price.

17. The method of claim 12, wherein the first warranty event is when the processor receives a signal indicating that the vehicle has been operated for at least a pre-configured distance.

18. The method of claim 12, wherein the first warranty event occurs when the processor receives a signal indicating that the vehicle has been in service for at least a pre-configured amount of time.

19. The method of claim 12, wherein the display is in the vehicle.

20. The method of claim 12, further comprising the steps of:
(e) configuring the transaction server to receive at least one disable signal in the set of disable signals consisting of:
(i) an indication that an alternate service contract has been purchased for the vehicle;
(ii) an indication that the vehicle is no longer in service;
(iii) an indication that the vehicle is no longer owned by the customer; and
(iv) an indication that an original warranty for the vehicle expired; and
(f) deactivating the integrated vehicle protection program in response to receiving a disable signal of the set of disable signals.
